(19) United States
(12) Patent Application Publication
(10) Pub. No.: US 2009/0211836 A1
(43) Pub. Date: Aug. 27, 2009

(54) Hydraulic Servo-Steering Device and Method for Controlling a Pump Drive Motor

(76) Inventors: Alexander Wiertz, Solingen (DE); Alexander Gaschka, Essen (DE); Arnd Pfeifer, Willich (DE)

Correspondence Address: MACMILLAN, SOBANSKI & TODD, LLC, ONE MARITIME PLAZA - FIFTH FLOOR, 720 WATER STREET, TOLEDO, OH, 43604, US

(21) Appl. No.: 11/991,571

(22) PCT Filed: Jul. 19, 2006
(86) PCT No.: PCT/EP2006/007114

§ 371 Date: Jan. 16, 2009

(30) Foreign Application Priority Data
Sep. 7, 2005 (DE) 10 2005 042 509.7

(51) Int. Cl. B62D 5/06; B62D 6/00

(52) U.S. Cl. 180/422; 701/41

(57) ABSTRACT

A hydraulic servo-steering device includes a pump and a pump drive motor. At least one defined high power stage (C) and one defined low power stage (B) are provided in which the motor is selectively operated. Moreover, a defined additional power stage (A) is provided for the motor, in which the speed of the motor is reduced with respect to the low power stage (B). According to a method for controlling the pump drive motor of the hydraulic servo-steering device, the motor is operated in the additional power stage (A) under certain conditions which rule out an impairment to driving safety.

### CROSS-REFERENCE TO RELATED APPLICATIONS

This application is a National Stage of International Application No. PCT/EP2006/007114 filed Jul. 19, 2006, the disclosures of which are incorporated herein by reference in their entirety, and which claimed priority to German Patent Application No. 10 2005 042 509.7 filed Sep. 7, 2005, the disclosures of which are incorporated herein by reference in their entirety.

### BACKGROUND OF THE INVENTION

The invention relates to a hydraulic servo-steering device including a pump and a pump drive motor, at least one defined high power stage and one defined low power stage being provided in which the motor is selectively operated. The invention further relates to a method for controlling the pump drive motor of such a hydraulic servo-steering device.

A generic servo-steering device for a motor vehicle is known from EP 0 673 328 B2, and corresponding U.S. Pat. No. 5,761,627, both of which are incorporated by reference herein, in which a hydraulic pump for conveying hydraulic fluid to a servo valve can be driven by an electric motor in two defined power stages, namely a stand-by operation and a full load operation. The current consumption of the motor is detected by means of a current sensor as a measure of the power requirement of the hydraulic pump. The current sensor is connected with a control unit which evaluates the values of the current sensor and if necessary carries out a changeover from one power stage of the motor into the other.

DE 103 25 848 A1, and corresponding U.S. patent No. 2006/151234, both of which are incorporated by reference herein, proposes providing a further, medium power stage between the high power stage and the low power stage. This intermediate stage makes possible a more flexible adaptation of the pump capacity to the respectively prevailing requirements.

DE 102 11 396 A1, and corresponding U.S. Pat. No. 7,055,644, both of which are incorporated by reference herein, shows a power-assisted steering with a pressure medium pump and a drive motor. A coupling is arranged between the pressure medium pump and the motor, so that the pressure medium pump is separable from the motor. The separation takes place in particular when no steering movement is taking place, i.e. when no hydraulic assistance is required.

### BRIEF SUMMARY OF THE INVENTION

It is an object of the invention to further develop a servo-steering device of the type initially mentioned such that the energy consumption of the servo-steering device can be reduced at a favorable cost.

This object is achieved in that in a servo-steering system of the type initially mentioned, a defined additional power stage is provided for the motor (hereinafter referred to as stage A), in which the speed of the motor is reduced compared with the low power stage (hereinafter referred to as stage B). The invention is based on the finding that no hydraulic steering assistance is necessary in certain driving situations and the function of the pump can be basically dispensed with entirely. In these situations, the motor is operated in the additional power stage (stage A) provided in accordance with the invention, in which the motor is not operated at all or is only operated at an extremely low speed. This operation can therefore also be referred to as “sleeping mode”. It is advantageous in the servo-steering device according to the invention that no coupling is necessary to separate the pump from the motor. It has been found that through the introduction of the additional power stage (stage A), not only can the average energy consumption of the servo-steering device be reduced, but also the CO₂ discharge can be distinctly reduced.

According to the preferred embodiment of the invention, the operation of the motor, in particular the setting of the speed, is controlled by software. In this way, a mechanical coupling or uncoupling of the pump can be dispensed with, because the power stage, and therefore the speed of the motor, is established by means of given criteria by a program stored in a control unit, the criteria being able to be adapted individually.

The invention also provides a method for controlling the pump drive motor of a hydraulic servo-steering device according to the invention, in which the motor is operated in the additional power stage (stage A) under certain conditions which rule out an impairment to driving safety.

The driver can “rouse” the motor/pump unit of the servo-steering device according to the invention. According to the preferred embodiment of the invention, provision is in fact made that in the case of defined steering movements, the additional power stage (stage A) is left automatically. Expediently, a changeover is then made from the additional power stage (stage A) into the low power stage (stage B).

Other advantages of the invention will become apparent to those skilled in the art from the following detailed description of the preferred embodiment, which reads in light of the accompanying drawing.

### BRIEF DESCRIPTION OF THE DRAWING

FIG. 1 shows a diagrammatic representation of the modes of operation of a pump drive motor in a servo-steering device according to the invention.

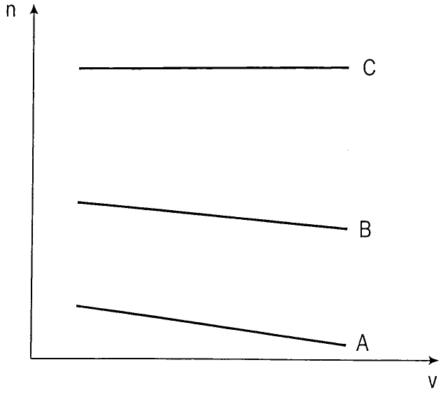

### DETAILED DESCRIPTION OF THE INVENTION

In the diagram of the FIGURE, the defined power stages in which the motor of the servo-steering device according to the invention can be operated are illustrated diagrammatically, the actual dependence of the speed n of the motor on the velocity v of the vehicle being able to deviate from the illustration in the diagram.

A high power stage C (full load) and a low power stage B (stand-by) are provided in a known manner. In full load operation, the motor is operated at a high speed n, so that the pump generates a high hydraulic flow. In stand-by operation, the speed n of the motor is reduced to such an extent that only a small hydraulic flow is maintained. In case of an increased power requirement for the pump, the motor is switched into full load operation, and in case of a low power requirement it is switched back into stand-by operation again. These two power stages therefore form an integral component of the steering cycle.

A medium power stage (load), which is not illustrated in the diagram, can be additionally provided between the power stages C and B.

A further defined power stage A is provided below the stand-by operation. In this power stage A, which does not constitute an integral component of the steering cycle and is referred to as “sleeping mode”, the speed n of the motor is significantly reduced again compared with the low power stage B.

The motor of the servo-steering device according to the invention is connected permanently (i.e. without a coupling) to the pump. The operation of the motor, in particular the setting of the speed, is undertaken by a programmed control unit. Under certain conditions which rule out an impairment to driving safety, the control unit has at its disposal a switchover into the additional power stage A. The sleeping mode is left automatically by defined steering movements of the driver, with a changeover into the usual operating stages of the steering then taking place.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

1. A hydraulic servo-steering device comprising:
a pump;
a pump drive motor having at least one defined high power stage and one defined low power stage in which the motor is selectively operated: and
a defined additional power stage is provided for the motor in which the speed n of the motor is reduced with respect to the low power stage.

2. The hydraulic servo-steering device according to claim 1, wherein the operation of the motor, in particular the setting of the motor speed, is controlled by software.

3. The hydraulic servo-steering device according to claim 1, wherein the motor is permanently coupled to the pump.

4. The hydraulic servo-steering device according to claim 3 wherein the motor is connected to the pump without a coupling.

5. The hydraulic servo-steering device according to claim 1, wherein under certain conditions which rule out an impairment to driving safety, the motor is operated in the additional power stage.

6. The hydraulic servo-steering device according to claim 5, wherein the additional power stage is left automatically in the case of defined steering movements.

7. The hydraulic servo-steering device according to claim 6, wherein a changeover is carried out from the additional power stage into the low power stage.

8. A method for controlling a hydraulic servo-steering device, the method comprising the steps of:
(a) providing a pump and a drive motor for the pump, the pump drive motor having at least one defined high power stage and one defined low power stage, the motor also having a defined additional power stage in which the speed of the motor is reduced with respect to the low power stage;
(b) selectively operating the motor in one of the high power stage and the low power stage; and
(c) operating the motor in the additional power stage under certain conditions which rule out an impairment to driving safety.

9. The method according to claim 8, wherein the additional power stage is left automatically in the case of defined steering movements.

10. The method according to claim 9, wherein a changeover is carried out from the additional power stage into the low power stage.
